(19) United States
(12) Patent Application Publication
(10) Pub. No.: US 2005/0144144 A1
(43) Pub. Date: Jun. 30, 2005

(54) System and method for authenticating a terminal based upon at least one characteristic of the terminal located at a position within an organization

(75) Inventor: Jon C. Graff, San Jose, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia, Inc., Irving, TX (US)

(21) Appl. No.: 10/749,042

(22) Filed: Dec. 30, 2003

(51) Int. Cl. G06F 17/60

(52) U.S. Cl. 705/76

(57) ABSTRACT

A system for authenticating a terminal includes a terminal included within an organization including a plurality of terminals, each having characteristic(s) and being at one or more positions within the organization. The system also includes a secondary certification authority (CA) capable of providing role certificate(s) to the terminal based upon the position(s) of the terminal, where the organization includes a plurality of secondary CA's capable of issuing role certificate(s) to respective groups of terminals of the organization. In addition, the system includes a tertiary CA capable of providing permission certificate(s) to the terminal based upon the characteristic(s) of the terminal, where the organization includes a plurality of tertiary CA's capable of issuing permission certificate(s) to respective sub-groups of terminals of the organization. The system further includes a server capable of authenticating the terminal based upon an identity certificate, the role certificate(s) and the permission certificate(s) of the terminal.

### FIELD OF THE INVENTION

The present invention generally relates to systems and methods for authenticating entities and, more particularly, to systems and methods for issuing permission certificates associated with role certificates and identity certificates for use to authenticate entities.

### BACKGROUND OF THE INVENTION

It is becoming increasingly common for transactions to be carried out by electronic means. In financial transactions, and in many other transactions, there is a need to establish a level of trust between the parties to the transaction. This basis for trust is a process called authentication. With authentication, one party supplies sufficient information and/or proof of identity to a second party. Additionally, authentication is frequently followed by the security procedure called authorization. In the authorization process, the first party supplies sufficient information and/or proof to a second party that the first party is permitted to perform some function or action. For example, if a purchaser wishes to buy goods on-line then the supplier of the goods must be satisfied that the purchaser will provide payment for the goods. The purchaser may also want to be satisfied that his payment is indeed to be transferred to the supplier.

One means for such trust to be established is by a public/private key system. In such a system each user has a pair of keys. One key is a public key, which can be made available to other users. The other key is a private key, which is held secret by the user whose key it is. The public and private keys are related by algorithms such that, whilst it is extremely difficult to generate the private key from knowledge of the public key, the private key and public key can be used for digital signing. In digital signing, a user supplies his private key and source data to a first algorithm. The resulting data, is often called a digital signature. This result data, i.e., the digital signature, and the source data can then be transmitted to another user. The other user applies a second algorithm to the first user's public key, the result data, and the source data and depending on the signature scheme, other input, to form verification data. The public and private key and the first and second algorithms are related such that the verification data indicates to high level of probability whether the first user's private key was used to generate the result data. Provided the first user's private key is secret to him, and that the second user can trust that the public key really belongs to the first user, this authenticates the first user to a high level of probability. An example of such a system is the Pretty Good Privacy (PGP) public/private key system.

A digital certificate is normally used to bind an identity of a subject to a public key. Certificates are themselves signed statements issued by a Certification Authority. If a user has the authority's public key, he can, verify certificates issued by that authority. If one user (verifier) has access to a certificate issued for the public key of another user (signer) by an authority trusted by the verifier, then the verifier can really trust that the public key belongs to the signer. This type of certificate is known as an identity certificate.

Whereas conventional Public Key Infrastructures (PKI's) that utilize certification authorities to generate identity certificates are adequate to identify users whose identities are bound to respective identity certificates, such infrastructures have drawbacks. In this regard, one of the major drawbacks of identity certificates lies in their strength. More particularly, identity certificates find strength in the generally lengthy, complex and time-consuming process conducted by certification authorities to prove the identity of the user requesting the respective identity certificates, and prove possession of the proper sets of required private-public key pairs, before issuing identity certificates.

Because of such a lengthy, complex and time-consuming identification process before issuing identity certificates, identity certificates are typically valid for lengthy periods of time and are typically difficult to re-issue. As a corollary, identity certificates can be thought of as the logical equivalent of a passport. Thus, because of the cost of creating and vetting identity certificates, identity certificates typically have relatively long lifetimes to thereby defray the costs of re-issuing such certificates. In this regard, recalling long-lived identity certificates is typically difficult, and methods such as certificate revocation lists (CRL's) and other such mechanisms to revoke identity certificates are typically cumbersome and loaded with operational difficulties.

### SUMMARY OF THE INVENTION

In light of the foregoing background, embodiments of the present invention provide an improved system and method for authenticating a terminal based upon at least one characteristic of the terminal located at a position within an organization. In contrast to conventional techniques for authenticating entities, embodiments of the present invention provide a primary certification authority (CA) capable of issuing identity certificates, secondary CA's capable of issuing role certificates based upon a position of the requesting terminal within an organization, and tertiary CA's capable of issuing permission certificates based upon characteristic(s) of the requesting terminal located at a position within the organization. The primary CA can be capable of issuing identity certificates to one or more organizations. One or more secondary CA's can be capable of issuing role certificates to one or more groups of terminals of one or more organizations. In turn, one or more tertiary CA's can advantageously be capable of issuing permission certificates to one or more sub-groups of terminals of one or more organizations. By distributing issuance of certificates between the primary, secondary and tertiary CA's, each respective CA can provide better control over the certificates issued by the respective CA.

Embodiments of the present invention are capable of further controlling access to resources without requiring re-issue or modification of an existing identity certificate, or an existing role certificate. Whereas each identity certificate can require a long, complex identification process to issue and can have a long life time, role certificates in accordance with embodiments of the present invention typically require a less lengthy and a less complex identification process by a secondary CA, but also typically have shorter life or valid times than identity certificates. Further, in accordance with embodiments of the present invention, permission certificates typically require a less lengthy and a less complex identification process by a tertiary CA, but also typically have shorter life or valid times than role certificates, and thus identity certificates. To establish a secure connection, then, a server can authenticate a terminal based upon not only a respective identity certificate, but also a respective role certificate and permission certificate.

According to one aspect of the present invention, a system is provided for authenticating a terminal. The system includes a terminal capable of communicating within and/or across at least one network. The terminal is included within an organization including a plurality of terminals, where one or more terminals have one or more characteristics and are at one or more of a plurality of positions within the organization. For example, the terminal can be included within an organization comprising a customer base of a cellular service provider that includes a plurality of terminals, where one or more terminals have characteristic(s) comprising optional services offered by the cellular service provider and where one or more terminals are at respective ones of a plurality of positions within the organization with each position comprising a respective service plan. Also, for example, the terminal can be included within a customer base of a cellular service provider, where the position of each terminal comprises one or more services offered by the cellular network operator.

The system includes a secondary certification authority (CA) capable of providing at least one role certificate to the terminal based upon the position(s) of the terminal within the organization. The system also includes a tertiary CA capable of providing at least one permission certificate to the terminal based upon the characteristic(s) of the terminal located at a position within the organization. Advantageously, the organization includes a plurality of secondary CA's capable of issuing role certificate(s) to respective groups of terminals of the organization, and a plurality of tertiary CA's capable of issuing permission certificate(s) to respective sub-groups of terminals of the organization. In addition, the system includes a server capable of authenticating the terminal based upon an identity certificate, the role certificate(s) and the permission certificate(s) of the terminal. As such, the server can determine whether to grant the terminal access to at least one resource of the server. In this regard, the terminal can be capable of requesting access to at least one resource of a server before the server authenticates the terminal. In such instances, the server can be capable of granting access to the at least one resource if the terminal is authenticated.

Each CA can be capable of providing a certificate including a validity time, which can specify the length of time a certificate is valid (e.g., start time to termination time). More particularly, the secondary CA can provide role certificate(s) including a validity time, and the tertiary CA can provide permission certificate(s) including a validity time. In such instances, the tertiary CA is capable of providing permission certificate(s) each having an associated validity time less than or equal to the validity time of the role certificate(s) provided by the secondary CA, and less than or equal to the validity time of the identity certificate. In such instances, the server can be capable of authenticating the terminal based upon the validity times of the identity certificate, role certificate(s) and permission certificate(s) of the respective terminal.

According to other aspects of the present invention, a terminal and method for authenticating a terminal are provided. Therefore, embodiments of the present invention provide an improved system and method for authenticating a terminal based upon characteristic(s) of the terminal located at a position within an organization. The system and method of embodiments of the present invention provide permission certificates in addition to identity and role certificates, thereby further controlling access to resources without requiring re-issue or modification of existing identity certificates or role certificates. Whereas the identity certificates can be issued by a primary CA capable of issuing identity certificates to one or more organizations, the role certificates can be issued by secondary CA's capable of issuing role certificates to one or more groups of terminals of one or more organizations. Further, the permission certificates can be issued by tertiary CA's capable of issuing permission certificates to one or more sub-groups of terminals of one or more organizations. By distributing issuance of certificates between the primary, secondary and tertiary CA's, each respective CA can provide better control over the certificates issued by the respective CA. Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for authenticating a terminal based upon at least one characteristic of the terminal located at a position within an organization, according to one embodiment of the present invention;

FIG. 2 is a schematic block diagram of an entity capable of operating as a network node, in accordance with embodiments of the present invention;

FIG. 3 is a schematic block diagram of a mobile station that may operate as a mobile terminal, and thus a client and/or a server, according to embodiments of the present invention;

FIG. 4 is a schematic block diagram of an organization and a divisional hierarchy of the same, in accordance with one embodiment of the present invention;

FIG. 5 is a block diagram of an exemplar organization comprising the customer base of a cellular service provider, in accordance with one embodiment of the present invention;

FIGS. 6A, 6B and 6C are flowcharts illustrating various steps in a method of obtaining identity, role and permission certificates, in accordance with one embodiment of the present invention; and

FIG. 7 is a flowchart illustrating various steps in a method of authenticating a terminal based upon at least one characteristic of the terminal located at a position within an organization, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

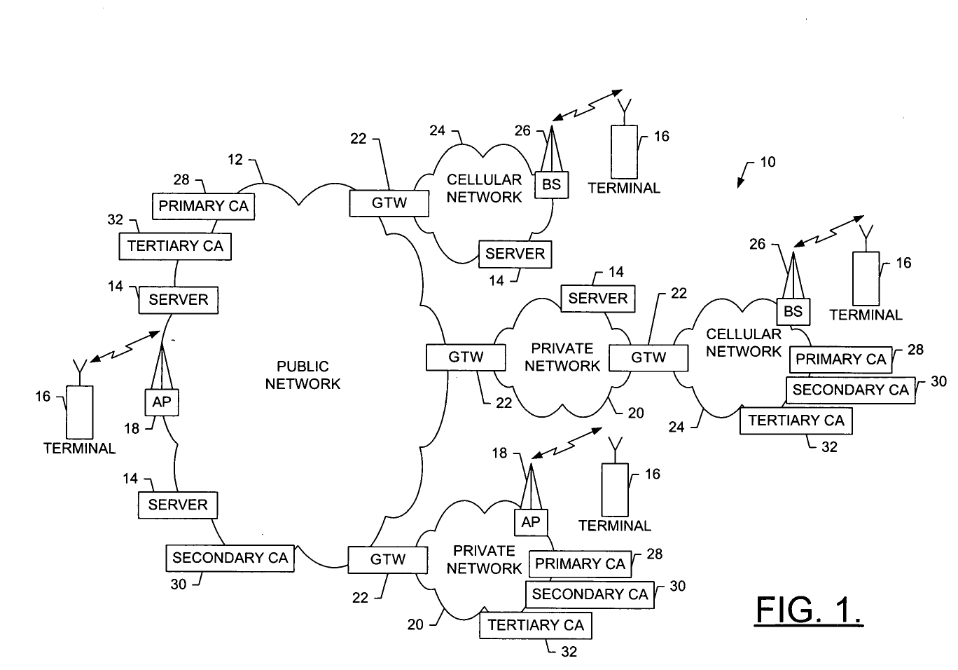

Referring to FIG. 1, an illustration of one type of system that would benefit from the present invention is provided. As shown, the system 10 includes a public network 12, such as a public Internet Protocol (IP) network like the Internet. The public network includes a number of network nodes, each of which typically comprise a processing element such as a server computer, personal computer, laptop computer or the like. More particularly, the public network can include one or more network nodes comprising server processors 14, workstations or the like (hereinafter individually referred to as a “server”), each of which are capable of communicating within or across the public network. The pubic network can also include one or more network nodes comprising mobile terminals 16, each of which are capable of communicating within or across the public network.

The terminals 16 can comprise, for example, mobile telephones, portable digital assistants (PDAs), pagers, laptop computers, smart cards and other types of electronic systems. To facilitate the terminals accessing the public network, the public network can include one or more wireless access points (AP's) 18, each of which can be coupled to one or more terminals. In this regard, the AP's can comprise access points configured to communicate with the terminal in accordance techniques such as, for example, radio frequency (RF), Bluetooth (BT), infrared (IRDA) or any of a number of different wireless networking techniques, including WLAN techniques. In accordance with embodiments of the present invention, one or more terminals are capable of operating as a client to communicate with one or more servers. It should be appreciated, however, that one or more terminals can additionally, or alternatively, be capable of operating as a server.

In addition to the public network 12, the system 10 can include one or more private networks 20, such as local area networks (LANs). Each private network, like the public network, can include a number of network nodes. Also, like the public network 12, the network nodes of one or more private networks can include one or more servers 14. One or more private networks can also, like the public network, include one or more network nodes comprising one or more mobile terminals 16, each of which can be coupled to an AP 18. Further, to facilitate communications between network nodes of the public network and network nodes of the private networks, each private network can further include a gateway processor (GTW) 22 interconnecting the public network and the private network.

The system 10 can also include one or more mobile or cellular networks 24. The cellular networks can comprise one or more of a number of different mobile networks. In this regard, the cellular networks can comprise any of a number of first-generation (1G), second-generation (2G), 2.5G and/or third-generation (3G) cellular networks, and/or any of a number of other cellular networks capable of operating in accordance with embodiments of the present invention. For example, each cellular network can comprise a GSM (Global System for Mobile Communication), IS-136 (Time Domain Multiple Access-TDMA), IS-95 (Code Division Multiple Access—CDMA), or EDGE (Enhanced Data GSM Environment) network. Alternatively, one or more of the cellular networks can comprise GPRS (General Radio Packet Service) or GPRS-based (e.g., Universal Mobile Telecommunications System—UMTS) networks.

Like the public and private networks 12, 20, the cellular networks 24 also include one or more network nodes. In this regard, the network modes of each cellular network can include mobile terminals capable of communicating within and/or across a respective cellular network. More particularly, as with the public and private networks, the cellular networks can include one or more servers 14. In addition, the cellular networks can include one or more network nodes comprising terminals 16. To couple each terminal to the cellular network, however, the cellular network includes a base site or base station (BS) 26. As will be appreciated, the BS is a part of the cellular network, which can also include other elements required to operate the cellular network, such as a mobile switching center (MSC) (not shown). Similar to before, to facilitate communications between network nodes of the public and/or private networks and network nodes of the cellular networks, each cellular network can further include a GTW 22 interconnecting the cellular network and a public or private network.

In accordance with embodiments of the present invention, one or more of the mobile terminals 16 of the public network 12, private networks 20, and/or cellular networks 24 are capable of operating as a client to communicate with one or more servers 14 for one or more of a number of different purposes. Alternatively, one or more of the terminals can operate as one or more servers in communication with other terminal(s) operating as client(s). More particularly, then, one or more of the mobile terminals are capable of communicating with one or more servers within the same or a different network, such as to request and thereafter receive one or more resources available from, or controlled by, the server. Before the terminal can communicate with a server, however, the terminal is capable of being authenticated by the server, as described in greater detail below. In this regard, to facilitate a server authenticating a terminal, the network nodes of one or more of the public network, private network(s) and cellular network(s) can also include one or more certification authorities (CA's), including one or more primary CA's 28, one or more secondary CA's 30 and/or one or more tertiary CA's 32, each of which are described in greater detail below.

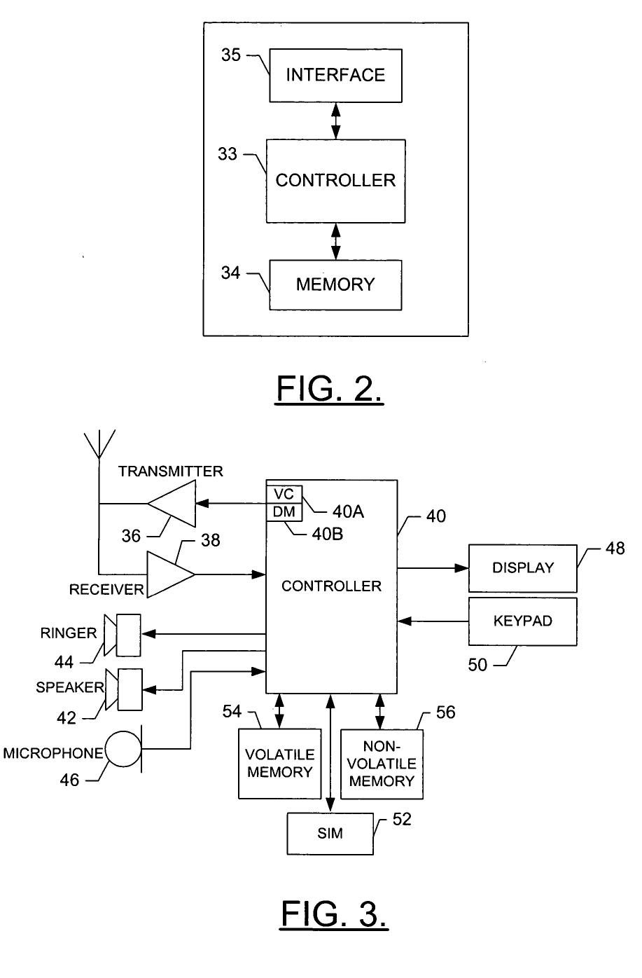

Reference is now made to FIG. 2, which illustrates a block diagram of an entity capable of operating as a network node (e.g., server 14, terminal 16, primary CA 28, secondary CA 30, tertiary CA 32, etc.) within the public network 12, private network(s) 20 or cellular network(s) 24, in accordance with one embodiment of the present invention. Although shown as separate entities, in some embodiments, one or more entities may support one or more of the network nodes, logically separated but co-located within the entit(ies). For example, a single entity may support a logically separate, but co-located, primary or secondary CA and server. Also, for example, a single entity may support a logically separate, but co-located primary CA and secondary CA. In yet another example, a single entity may support a logically separate, but co-located secondary CA and tertiary CA.

As shown, the entity capable of operating as a network node can generally include a controller 33, processor or the like connected to a memory 34. The controller can also be connected to at least one interface 35 or other means for transmitting and/or receiving data, content or the like. The memory can comprise volatile and/or non-volatile memory, and typically stores content, data or the like. For example, the memory typically stores software applications, instructions or the like for the controller to perform steps associated with operation of the entity in accordance with embodiments of the present invention. Also, for example, when the network node comprises a terminal, the memory can store a public/private key pair, as well as an identity certificate issued by a primary CA 28, and role certificate issued by a secondary CA 30 and at least one permission certificate issued by a tertiary CA 32.

FIG. 3 illustrates a functional diagram of a mobile station that may operate as a mobile terminal, according to embodiments of the invention. It should be understood, that the mobile station illustrated and hereinafter described is merely illustrative of one type of mobile terminal that would benefit from the present invention and, therefore, should not be taken to limit the scope of the present invention. While several embodiments of the mobile station are illustrated and will be hereinafter described for purposes of example, other types of mobile terminals, such as portable digital assistants (PDAs), pagers, laptop computers, smart cards and other types of voice and text communications systems, can readily employ the present invention.

The mobile station includes a transmitter 36, a receiver 38, and a controller 40 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of 1G, 2G, 2.5G and/or 3G communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 40 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 40A, and may include an internal data modem (DM) 40B. Further, the controller may include the functionally to operate one or more software applications, which may be stored in memory.

The mobile station also comprises a user interface including a conventional earphone or speaker 42, a ringer 44, a microphone 46, a display 48, and a user input interface, all of which are coupled to the controller 40. The user input interface, which allows the mobile station to receive data, can comprise any of a number of devices allowing the mobile station to receive data, such as a keypad 50, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 52, a removable user identity module (R-UIM) or the like, which typically stores information elements related to a mobile subscriber. In addition to the SIM, the mobile station can include other memory. In this regard, the mobile station can include volatile memory 54, as well as other non-volatile memory 56, which can be embedded and/or may be removable. For example, the other non-volatile memory can comprise embedded or removable multimedia memory cards (MMC's), memory sticks, EEPROM, flash memory, hard disk or the like. The memories can store any of a number of pieces of information, and data, used by the mobile station to implement the functions of the mobile station. For example, the memories can store an identifier, such as an international mobile equipment identification (IMEI) code, international mobile subscriber identification (IMSI) code, mobile station integrated services digital network (MSISDN) code or the like, capable of uniquely identifying the mobile station. The memories can also store one or more public/private key pairs, with each public key bound to an identity certificate, also stored by the memories. In addition, the memories can store one or more role certificates, each of which being bound to one or more identity certificates, as described below.

Although not shown, the mobile station can further include one or more means for locally sharing data with one or more other network nodes, such as AP's 18. For example, the mobile station can include an infrared transceiver or another local data transfer device so that data can be shared with and/or obtained from other devices such as other mobile stations, car guidance systems, personal computers, printers or the like. The sharing of data, as well as the remote sharing of data, can also be provided according to a number of different techniques. For example, the mobile station can include a radio frequency (RF) transceiver capable of sharing data with other radio frequency transceivers, and/or with a Radio Frequency Identification (RFID) transponder tag, as such is known to those skilled in the art. Additionally, or alternatively, the mobile station may share data using Bluetooth brand wireless technology developed by the Bluetooth Special Interest Group.

As indicated above in the background section, it is also known that security issues are present with regard to network nodes communicating over and across networks, such as public networks 12, private networks 20 and cellular networks 24, where such security issues include such issues as eavesdropping, tampering, and impersonation (including spoofing and misrepresentation). To address such issues, techniques such as public-key cryptography have been developed to facilitate authentication of the origin of a communication. As is well known to those skilled in the art, authentication can generally be defined as the ability to allow the recipient of information to determine the identity of the sender.

In accordance with a number of public-key cryptography techniques, an identity certificate can be used to assist in authentication, where such an identity certificate typically comprises an electronic document that identifies an individual or other entity (e.g., terminal). This electronic document can be digitally signed with a private-public key pair issued by a Certification Authority (CA). The combination of the electronic document and its accompanying digital signature, then, is often referred to as a digital certificate. As will be appreciated, a CA is typically an independent third party that can generate a private-public key pair. Thereafter, the CA can generate a corresponding certificate that binds the public key to the identity of the terminal 16 that the identity certificate identifies. Thus for instance, if a user of a terminal wants a certificate and can meet the identification requirements of the CA (the published methods that the CA uses to validate an identity), then the CA can issue an identity certificate. The public key can be used by anyone to decrypt a message, that is, validate the digital signature, which has been encrypted using the corresponding private key. In this regard, if a terminal has an identity certificate, the terminal can distribute that certificate to a server 14 and can send a message, and the terminal's digital signature of that message, to the server. Thus, the ability of the server to validate the signature for that message with the terminal's public key that is included within the certificate effectively forms the basis for the server to have assurance that the entity (i.e., terminal) identified in this certificate is in fact the same as the entity which transmitted the encrypted information to the server.

Public-key cryptography techniques can form the basis for establishing a secure connection (session) between a server 14 and a terminal 16. In this regard, the secure connection can be made in accordance with any of a number of different secure session protocols, such as Transport Layer Security (TLS), Wireless TLS (WTLS), IP Security Protocol (EPSec), Secure Socket Layer (SSL) or the like. For example, SSL is a protocol that uses a public-key cryptographic system to establish a symmetric private key known only to the terminal and the server. Once the symmetric private key has been established between the terminal and the server, the symmetric key provides the basis for both encryption and decryption of secured communications between the terminal and the server. The certification process with the associated use of the private-public key of the certificate holder forms the basis for assuring either party of the identity of the other party (through use of the other party's certificate), as well as forms the basis for communicating information to establish the use of a particular secret symmetric key for use during a particular SSL session.

As also indicated in the background section, whereas conventional Public Key Infrastructures (PKI's) that utilize certification authorities to generate identity certificates are adequate to identify users whose identities are bound to respective identity certificates, such infrastructures have drawbacks. Because of the cost of creating and vetting identity certificates, identity certificates typically have relatively long lifetimes to thereby defray the costs of re-issuing such certificates. In this regard, recalling a long-lived identity certificate is typically difficult, and methods such as certificate revocation lists (CRL's) and other such mechanisms to revoke identity certificates are typically cumbersome and loaded with operational difficulties.

In accordance with embodiments of the present invention, primary CA's 28 are capable of issuing identity certificates to terminals 16, such as in accordance with any of a number of known techniques. To further control access to resources without requiring re-issue or modification of an existing identity certificate, in addition to an identity certificate, one or more terminals are also capable of storing role certificates. Then, to provide added access control to resources without requiring re-issue or modification of an existing role certificate, one or more terminals can be further capable of storing permission certificates. Whereas each identity certificate can require a long, complex identification process to issue and can have a long lifetime, role certificates typically require a less lengthy and a less complex identification process by a secondary CA 30, but also typically have shorter life or valid times than identity certificates. Similarly, permission certificates can require an even less lengthy and less complex identification process by a secondary CA, or in one typical embodiment, a tertiary CA 32. As such, permission certificates also typically have shorter life or valid times than role certificates.

Identity certificates are typically issued by a primary CA 28 based upon the identity of an associated entity (i.e., terminal 16). Role certificates, on the other hand, can be issued by a respective secondary CA 30 based upon a position of the requesting terminal within an organization. Permission certificates, then, can be issued by a tertiary CA 32 based upon at least one characteristic of the requesting terminal located its respective position within the organization. To establish a secure connection, then, a server can authenticate a terminal based upon not only a respective identity certificate, but also a respective role certificate and at least one permission certificate. Advantageously, the primary CA can be capable of issuing identity certificates to one or more organizations, with one or more secondary CA's capable of issuing role certificates to one or more respective groups of terminals of one or more organizations. Tertiary CA's, then, can be capable of issuing permission certificates to one or more sub-groups of terminals, or one or more terminals within one or more groups of terminals. By distributing issuance of certificates between the primary, secondary and tertiary CA's, each respective CA can provide better control over the certificates issued by the respective CA.

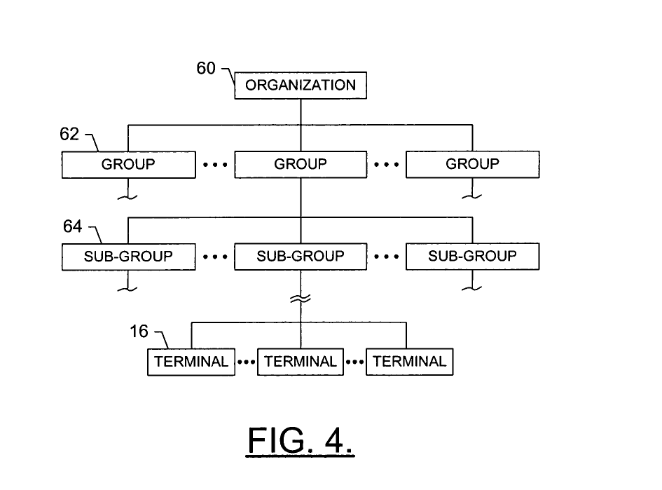

As indicated above, a primary CA 28 can be capable of issuing identity certificates to terminals 16, where the terminals can be members of an organization 60, as shown in FIG. 4. The organization can comprise any of a number of different types of organizations, such as a corporation, business, geographic area, network or the like. For example, the organization can comprise a network (e.g., public network 12, private network 20, or cellular network 24) provider. In such instances, the terminals can comprise, possessed by or otherwise associated with any of a number of different entities associated with the respective organization, including employees, customers or the like. Irrespective of the organization and the terminals, however, the organization can advantageously be divided into a one or more groups over one or more hierarchical levels within the organization. As shown in FIG. 4, for example, the organization can be divided into a number of groups 62, with each group divided into one or more sub-groups 64. Each sub-group, then, can include one or more terminals. Although each terminal is shown and described herein as being located at a position within an organization, as will be appreciated, one or more terminals can be located at more than one position within an organization. For example, one or more terminals can be located within more than one sub-group of one or more groups within an organization.

In one typical scenario, the organization 60 can comprise a corporation, with the corporation divided into a plurality of divisions (i.e., groups 62) that each include a terminal 16 possessed by a division head or leader. Each division head oversees, and thus each division can be further divided into, a plurality of departments, with each respective department including a terminal possessed a department head or leader. Similarly, then, each department head oversees, and thus each department can include, a plurality of employees that each possess a terminal, where one or more of the employees can have a different position (e.g., job) within a respective department. One or more employees within each department can also have one or more characteristics for the position of the employee within the respective department. For example, one or more employees within a given department can have characteristics such as working hours, locations, responsibilities, access permissions or the like. In accordance with embodiments of the present invention, as indicated above, a primary CA 28 is capable of issuing identity certificates to the terminals of one or more organizations. For each organization, then, the primary CA can issue identity certificates to the respective terminals across each group and any sub-groups, irrespective of any characteristics of the terminals.

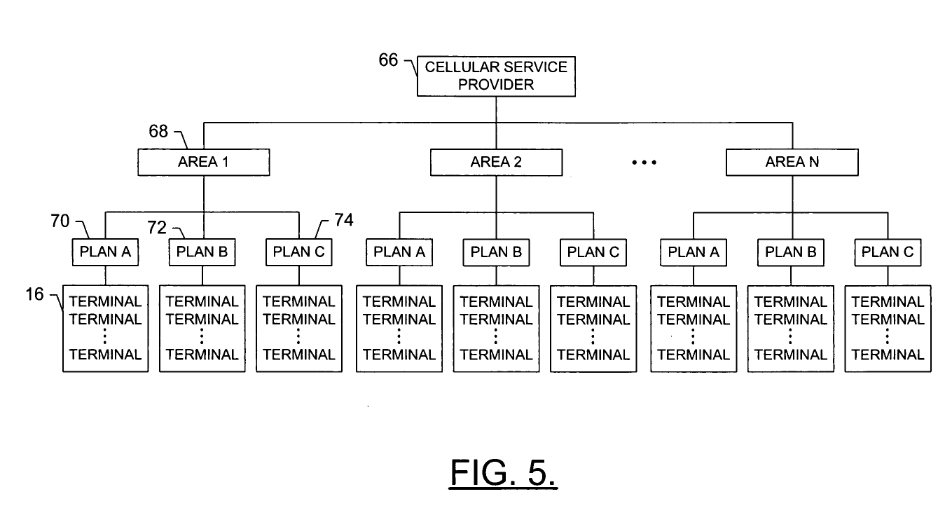

In another typical scenario, shown in FIG. 5, the organization 60 can comprise the customer base of a business, such as a customer base of a cellular service provider 66 offering one or more cellular services within and/or across one or more cellular networks 24. In such an instance, the cellular service provider can have a plurality of mobile customers, with each customer operating a terminal 16 subscribing to one or more of a number of different service plans. More particularly, the organization can be divided into a number of geographic areas 68, namely areas 1, 2, . . . N. Within each area, then, the organization can be further divided based upon a service plan subscribed to by each of the mobile customers within the respective area.

As shown in FIG. 5, for example, the organization can be divided into those customers having terminals subscribing to service plan A 70, service plan B 72 or service plan C 74. In this regard, service plan A can be subscribed to by “preferred” customers whose respective terminals have unlimited access to the cellular network(s) of the service provider. Service plan B can be subscribed to by “normal” customers whose respective terminals have access to the cellular network(s) for a predefined duration over each of a number of time periods (e.g., predefined number of access minutes per month). In contrast, service plan C can be subscribed to by “restricted” customers whose respective terminals have restricted access to the network, such as access within a particular geographic or logical area, a limited number of accesses to the cellular network(s), and/or access to the network for particular purposes (e.g., emergency access).

Within each service plan, one or more customers subscribing to each service plan can have one or more characteristics of the respective service plan. For example, one or more customers under service plans A, B and/or C can further subscribe to optional services, such as messaging services (e.g., e-mail, SMS, MMS, etc.), extended access to the cellular network(s), or the like. Similar to before, a primary CA 28 can be capable of issuing identity certificates to the terminals of the organization, irrespective of the level of service plan offered to the respective terminals, and irrespective of any characteristics of the respective terminals.

As will be appreciated, the service plan offered to each “normal” customer (service plan B) can include the service plan offered to the “restricted” customer (service plan C), in addition to other services not otherwise within the plan of the “restricted” customer. Likewise, the service plan offered to each “preferred” customer (service plan A) can include the services offered to the “normal” customer (and hence the “restricted” customer), in addition to other services not otherwise within the plan of the “normal” customer (and hence the “restricted” customer). In this regard, each service plan can be arranged to only include those services not otherwise offered under any other plan, with service plan C designated as a base or basic plan. Thus, although the customers with each different type of service plan can be located within a different position of the organization, the organization can be arranged such that the customers are positioned in accordance with the services offered under each type of service plan are located within a different position of the organization. In such an arrangement, then, the “preferred” customers can have multiple positions within the organization, where the positions correspond to the services offered under service plans A, B and C. Similarly, the “normal customers” can have multiple positions within the organization, where the positions correspond to the services offered under service plans B and C. Because “restricted” customers have the lowest service plan, “restricted” customers only have a position corresponding to the services offered under service plan C.

As will be appreciated by those skilled in the art, an identity certificate binds the name or identity of a terminal to a public key, with the respective terminal storing a private key associated with the public key. Thus, an identity certificate provides a way to indicate the authenticity of a holder of a public key. The identity certificates issued by a primary CA 28, which can be based upon the International Telecommunication Union (ITU) standard X.509, for example, can include at least a public key, a serial number and validity time of the certificate, a digital signature of the primary CA, and can identify the holder of the key (i.e., terminal) and the primary CA (certificate granter). See ITU Recommendation X.509, entitled: Information Technology—Open Systems Interconnection—The Directory: Public Key and Attribute Certificate Frameworks; International Standard ISO/IEC 9594-8; and Internet Engineering Task Force (IETF) Request For Comments (RFC) document RFC 3280, entitled: Internet X.509 Public Key Infrastructure Certificate and Certificate Revocation List (CRL) Profile, the contents of all of which are hereby incorporated by reference in its entirety.

As also indicated above, a secondary CA 30 can be capable of issuing role certificates to terminals 16 based upon a position of the terminal within a respective organization 60, as shown in FIG. 4. In this regard, a secondary CA can be capable of issuing role certificates to the terminals of one or more groups 62, or the like of the organization. For example, each of a plurality of secondary CA's can be capable of issuing role certificates to a group within the organization, and thus the terminals within and underneath the group. Continuing the corporation scenario above, then, each of a plurality of CA's can be capable of issuing role certificates to employees (i.e., users of terminals) within a particular division, including the employees within each of the departments of the particular division. Also, continuing the cellular service provider 66 scenario, above, each of a plurality of secondary CA's can be capable of issuing role certificates to mobile customers within a geographic area 68, i.e., geographic area 1, 2, . . . N.

Each role certificate binds a terminal 16 to a position within a respective organization 60. Thus, each role certificate provides a way to indicate the authenticity of a terminal within an organization, such as within a group, sub-group or the like. The role certificates issued by a secondary CA 30 can be based upon, for example, attribute certificates defined by ITU standard X.509. For more information on such attribute certificates, see ITU Recommendation X.509; ISO/IEC 9594-8; and Internet Engineering Task Force (IETF) Request For Comments (RFC) document RFC 3281, entitled: An Internet Attribute Certificate Profile for Authentication, the contents of all of which are hereby incorporated by reference in its entirety. More particularly, for example, each role certificate can include at least a serial number and validity time of the certificate, a digital signature of the secondary CA, and can identify the holder of the certificate (i.e., terminal) and the secondary CA (certificate granter). In addition, for example, each role certificate can include one or more attributes of the terminal, such as the position of the terminal within the organization.

Unlike identity certificates, role certificates typically do not include a public key corresponding to a private key stored by respective terminals 16. Thus, by themselves, role certificates typically do not bind the name or identity of a terminal to a public key. In this regard, each terminal within an organization can store an identity certificate issued by a primary CA 28, as well as one or more role certificates issued by one or more secondary CA's 30. As such, each role certificate can be bound to, or otherwise associated with, the identity certificate of the respective terminal. In this regard, each role certificate can further identify a bound identity certificate of the respective terminal. Irrespective of the exact contents of each role certificate, each role certificate typically has a shorter valid lifetime than the bound identity certificate, and as such, can be issued by a secondary CA with a less lengthy and less complex identification process than that required by the primary CA in issuing the bound identity certificate. Thus, by issuing each role certificate based upon a position of a terminal within an organization, and by binding each role certificate to an identity certificate, the system 10 can provide increased granularity in the control of access to resources of a server 14, than conventional systems only utilizing identity certificates.

A tertiary CA 32 can be capable of issuing permission certificates to terminals 16 based upon at least one characteristic of the terminal located at its respective position within the organization 60. In this regard, a tertiary CA can be capable of issuing permission certificates to the terminals of one or more sub-groups 64 or the like of the organization, as shown in FIG. 4. For example, each of a plurality of tertiary CA's can be capable of issuing role certificates to a sub-group within the organization, and thus the terminals within and underneath the sub-group. Continuing the corporation scenario above, then, each of a plurality of CA's can be capable of issuing role certificates to employees (i.e., users of terminals) within a particular department of a particular division. Also, continuing the cellular service provider 66 scenario, above, each of a plurality of tertiary CA's can be capable of issuing permission certificates to mobile customers within a particular service plan 70, i.e., plan A, B or C. Although each terminal can be located within a sub-group of a group of the organization, it should be understood that the terminals of one or more sub-groups can be included within more than one group, and thus sub-group, of the organization. As such, one or more terminals can be capable of receiving one or more permission certificates for one or more sub-groups of one or more groups of the organization.

Each permission certificate binds a terminal 16 to at least one characteristic of the terminal located at the position of the respective terminal within a respective organization 60. Thus, each permission certificate provides a way to indicate authorizations of a terminal located at a position within an organization. Like role certificates, the permission certificates issued by a tertiary CA 32 can be based upon, for example, attribute certificates defined by ITU standard X.509. More particularly, for example, each permission certificate can include at least a serial number and validity time of the certificate, a digital signature of the tertiary CA, and can identify the holder of the certificate (i.e., terminal) and the tertiary CA (certificate granter). In addition, for example, each permission certificate can include one or more attributes of the terminal, such as one or more characteristics of the terminal located at its position within the organization.

Like role certificates, permission certificates typically do not include a public key corresponding to a private key stored by respective terminals 16. Unlike role certificates, however, permission certificates typically do not include the position of the terminal within the organization. Thus, by themselves, permission certificates typically do not bind the name or identity of a terminal to a public key, nor do permission certificates bind the name or identity of a terminal to a position of the terminal within an organization. In this regard, each terminal within an organization can store an identity certificate issued by a primary CA 28, as well as one or more role certificates issued by one or more secondary CA's 30, and one or more permission certificates issued by one or more tertiary CA's 32. As such, each permission certificate can be bound to, or otherwise associated with, one or more role certificates of the respective terminal, where as indicated above, the role certificate(s) can be bound to the identity certificate of the respective terminal. In this regard, each permission certificate can further identify a bound role certificate of the respective terminal. As will be appreciated then, each permission certificate can be considered to be bound to one or more role certificates and an identity certificate.

Irrespective of the exact contents of each permission certificate, each permission certificate typically has a shorter valid lifetime than the bound role certificate, and as such, the identity certificate bound to the respective role certificate. Permission certificates can therefore be issued by a tertiary CA 32 with a less lengthy and less complex identification process than that required by the secondary CA 30 in issuing the bound role certificate, and a less lengthy and less complex identification process than that required by the primary CA in issuing a respective identity certificate. Thus, by issuing each permission certificate based upon at least one characteristic of a terminal, and by binding each permission certificate to a role certificate and therefore an identity certificate, the system 10 can provide added granularity in the control of access to resources of a server 14, as compared to conventional systems only utilizing identity certificates, and systems utilizing identity and role certificates.

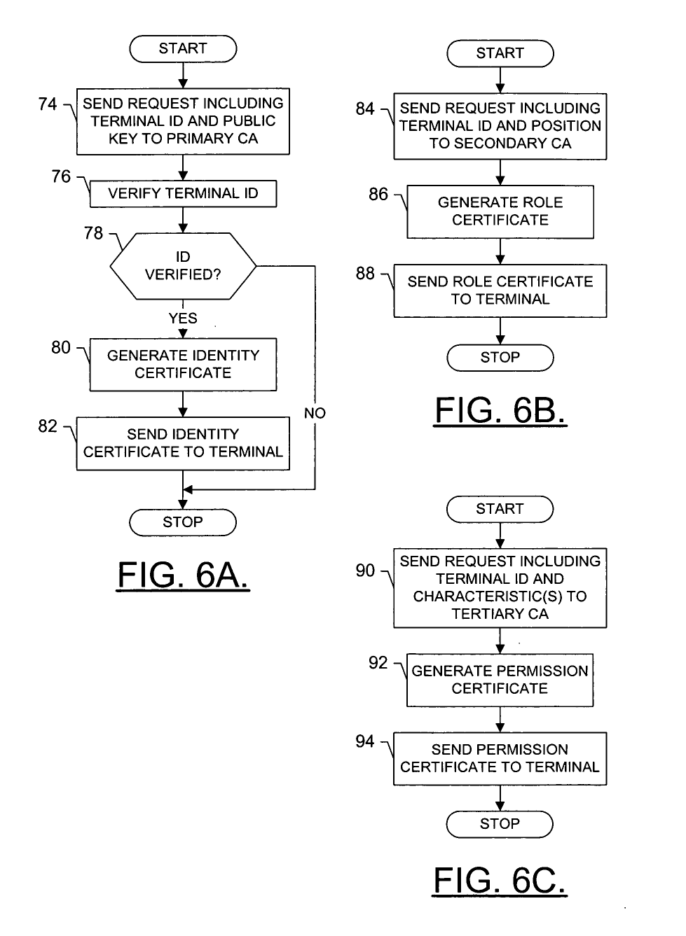

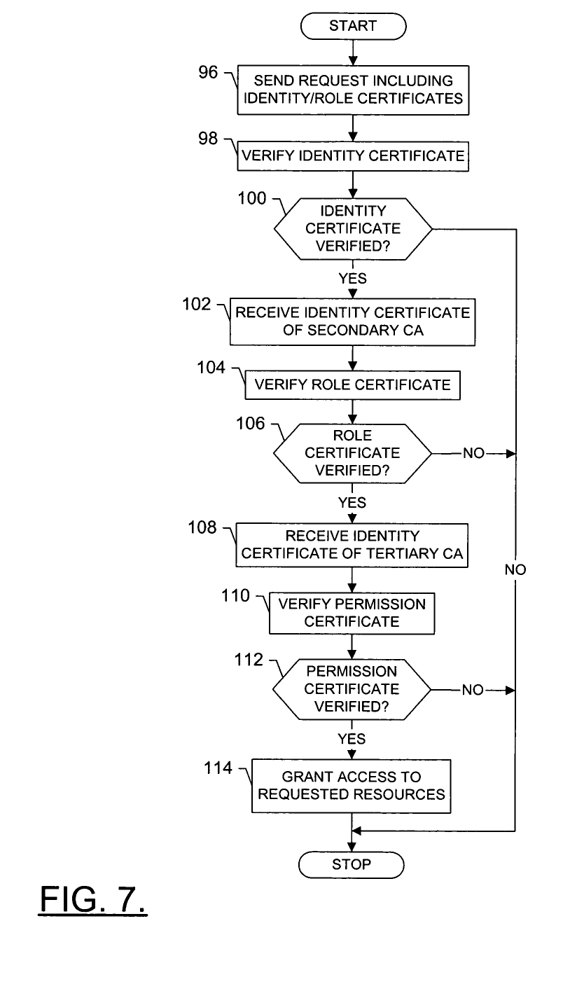

Reference is now made to FIGS. 6A, 6B and 7, which illustrate a method of authenticating a terminal 16 at a server 14 based upon at least one characteristic of the terminal located at a position within an organization, in accordance with one embodiment of the present invention. Generally, the method includes the terminal obtaining, generating or otherwise receiving a public/private key pair. The terminal can thereafter communicate with a primary CA 28 to obtain, and store, an identity certificate that binds an identity of the terminal to the public key of the public/private key pair. Then, the terminal can communicate with one or more secondary CA's 30 to obtain, and store, one or more role certificates based upon one or more positions of the terminal within an organization, where the role certificate(s) bind the position(s) of the terminal with the identity certificate of the terminal. After obtaining the role certificate(s), the terminal can communicate with one or more tertiary CA's 32 to obtain, and store, one or more permission certificates based upon one or more characteristics of the terminal located at respective position(s) within the organization. After obtaining the identity certificate, role certificate(s) and permission certificate(s), the terminal can authenticate itself to one or more servers, such as to thereby access resources of the respective servers. For example, the terminal can use the identity certificate, role certificate(s) and permission certificate(s) to authenticate itself to a server (e.g., MSC) of a cellular network to thereby access one or more resources of the cellular network that are controlled by the server, where the server can be controlled by the cellular service provider 66 (see FIG. 5).

More particularly, referring to FIG. 6A, a method of authenticating a terminal 16 can include the terminal obtaining an identity certificate from a primary CA 28. To obtain such an identity certificate, the terminal, or more particularly a user of the terminal, can send a request to the primary CA for an identity certificate, as shown in block 74. The request generally includes a public key of a public/private key pair stored by the terminal. The request also generally identifies the terminal, or user of the terminal. For example, the request can include an IMEI code, IMSI code, MSISDN code or the like to thereby identify the terminal. Upon receipt of the request, the primary CA can verify the identity of the terminal in any of a number of known manners, as shown in blocks 76 and 78. If the identity is not verified, the primary CA can refuse to provide the terminal with an identity certificate. As shown in block 80, however, if the primary CA does verify the identity of the terminal, the primary CA can thereafter generate an identity certificate for the terminal by binding the identity of the terminal with the public key of the terminal, such as by encrypting the identity and public key with a private key of the primary CA. In this regard, as will be appreciated, the primary CA (as well as each secondary CA) also stores a respective public/private key pair. And as indicated above, the identity certificate can include any of a number of other pieces of information, such as a serial number and validity time of the certificate, a digital signature of the primary CA, and can identify the primary CA (certificate granter). Irrespective of how the primary CA generates the identity certificate, and the exact contents of the identity certificate, after generating the identity certificate, the primary CA can send the identity certificate back to the terminal, such as in response to the request from the terminal, as shown in block 82. The terminal can then store the identity certificate.

Irrespective of how the terminal 16 obtains an identity certificate, after obtaining the identity certificate, the terminal can obtain one or more role certificates based upon a position of the terminal, or user of the terminal, within an organization. As shown in FIG. 6B, in accordance with one embodiment of the present invention, a method of obtaining each role certificate can include sending a request to a secondary CA 30 for a role certificate, as shown in block 84. The request can be sent from the terminal, but in a more typical embodiment, the request is sent from an entity capable of controlling the terminal's access to resources of a server 14. For example, in the above corporation example, the request for a role certificate can be sent by a division head or leader, which may be capable of directly interfacing with the secondary CA. Also, for example, in the above cellular service provider example, the request for a role certificate can be sent by the service provider.

Irrespective of who sends the request for a role certificate, the request for a role certificate generally includes the position of the respective terminal within an organization. For example, in the corporate example above, the request can identify the organization, division, and department of the terminal, or user of the terminal. Also, for example, in the cellular service example above, the request can identify the service plan(s) available, or subscribed, to the respective terminal. As with the request for an identity certificate, the request also generally identifies the terminal, or user of the terminal, such as by including an IMEI code, IMSI code, MSISDN code or the like of the terminal. In addition, to bind the identity certificate of the terminal to the role certificate, the request can identify the identity certificate of the terminal.

Upon receipt of the request for a role certificate, the secondary CA 30 can generate a role certificate for the terminal by binding the identity of the terminal with the position of the terminal within the organization, as shown in block 86. For example, similar to before, the secondary CA can bind the identity of the terminal with the position of the terminal by encrypting the identity and identified position with a private key of the secondary CA, which like the primary CA, also stores a respective public/private key pair. And as indicated above, the role certificate can include any of a number of other pieces of information, such as a serial number and validity time of the certificate, a digital signature of the secondary CA, and can identify the secondary CA (certificate granter) and a bound identity certificate of the terminal. Irrespective of how the secondary CA generates the role certificate and the exact contents of the role certificate, after generating the role certificate, the secondary CA can send the role certificate to the terminal, such as in response to the request for the role certificate, as shown in block 88. Thereafter, the terminal can store the role certificate.

Irrespective of how the terminal 16 obtains an identity or role certificates, after obtaining the role certificate, the terminal can obtain one or more permission certificates based upon at least one characteristic of the terminal located at a position of the terminal, or user of the terminal, within an organization. As shown in FIG. 6C, in accordance with one embodiment of the present invention, a method of obtaining each permission certificate can include sending a request to a tertiary CA 32 for a permission certificate, as shown in block 90. The request can be sent from the terminal, but in a more typical embodiment, the request is sent from an entity capable of controlling the terminal's access to resources of a server 14. For example, in the above corporation example, the request for a permission certificate can be sent by a department head or leader, which may be capable of directly interfacing with the tertiary CA. Also, for example, in the above cellular service provider example, the request for a permission certificate can be sent by the service provider.

Irrespective of who sends the request for a permission certificate, the request for a permission certificate generally includes at least one characteristic of the respective terminal. For example, in the corporate example above, the request can identify the working hours, locations, responsibilities, access permissions or the like of an employee possessing the terminal. Also, for example, in the cellular service example above, the request can identify the optional services, such as messaging services (e.g., e-mail, SMS, MMS, etc.), extended access to the cellular network(s) or the like, available, or subscribed, to the respective terminal. As with the request for an identity certificate and role certificate, the request for a permission certificate also generally identifies the terminal, or user of the terminal, such as by including an IMEI code, 'MSI code, MSISDN code or the like of the terminal. In addition, to bind at least one role certificate of the terminal to the permission certificate, the request can identify one or more role certificates of the terminal.

Upon receipt of the request for a permission certificate, the tertiary CA 32 can generate a permission certificate for the terminal by binding the identity of the terminal with the characteristic(s) of the terminal located at a position within the organization, as shown in block 92. For example, similar to before, the tertiary CA can bind the identity of the terminal with the characteristic(s) of the terminal by encrypting the identity and identified characteristic(s) with a private key of the tertiary CA, which like the primary and secondary CA's 28, 30, also stores a respective public/private key pair. And as indicated above, the permission certificate can include any of a number of other pieces of information, such as a serial number and validity time of the certificate, a digital signature of the tertiary CA, and can identify the tertiary CA (certificate granter) and a bound role certificate of the terminal. Irrespective of how the tertiary CA generates the permission certificate and the exact contents of the permission certificate, after generating the permission certificate, the tertiary CA can send the permission certificate to the terminal, such as in response to the request for the permission certificate, as shown in block 94. Thereafter, the terminal can store the permission certificate.

At one or more points in time after the terminal 16 stores the identity certificate, role certificate(s) and permission certificate(s), the terminal can initiate communication with one or more servers 14 to thereby request access to resources available from, or controlled by, the server(s). As shown in FIG. 7, a terminal can request access the resources of the server by first sending a request to the server, where the request includes permission certificate and a bound role certificate, along with an identity certificate bound to the role certificate, as shown in block 96. In this regard, the server can be capable of permitting the terminal to access resources of the server in accordance with the characteristic(s) of the terminal identified in the permission certificate, the terminal being at a position identified in the role certificate. Before permitting such access, however, the server can validate the permission certificate, role certificate and identity certificate to thereby authenticate and authorize the terminal for access to the resources.

More particularly, upon receipt of the permission, role and identity certificates, the server 14 can verify the identity of the terminal based upon the identity certificate, as shown in blocks 98 and 100. The server can verify the identity of the terminal in any of a number of different manners. In one typical embodiment, for example, the server verifies the identity of the terminal based upon the public key of the primary CA 28, a digital signature of the terminal, and the identity of the terminal, public key of the terminal and digital signature of the primary CA included within the identity certificate, all of which can be provided by the terminal. In addition, the server can validate the identity certificate based upon other parameters of the identity certificate. For example, the server can validate the identity certificate in accordance with the validity time of the identity certificate such as by determining if the identity certificate is expired. Irrespective of how the server verifies and validates the identity of the terminal, however, if the server fails to verify or validate the identity of the terminal, the server can refuse to permit the terminal to access the resources of the server.

If the server 14 verifies and validates the identity certificate the terminal 16, the server can continue by verifying the position of the terminal within the organization based upon the role certificate, to thereby determine if and to what extent the terminal is authorized to access the resources of the server. Like verifying the identity of the terminal, the server can verify the position of the terminal within the organization in any of a number of different manners. In one typical embodiment, however, the server requires an identity certificate of the secondary CA 30 to verify the role certificate, and thus the position, of the terminal. As shown in block 102, the server can therefore receive the identity certificate of the secondary CA, such as from the terminal, the secondary CA or another depository, in accordance with any of a number of known techniques. As will be appreciated, the server can receive the identity certificate of the secondary CA at any time before verifying the role certificate, such as after receiving the identity and role certificates from the terminal (see block 96).

As shown in blocks 104 and 106, after receiving the identity certificate of the secondary CA 30, the server 14 can verify the role certificate by verifying the identity of the secondary CA, and if verified, further based upon the public key of the secondary CA, the digital signature of the terminal, and the identity of the terminal, position of the terminal and digital signature of the secondary CA included within the role certificate. Like verifying the identity certificate of the terminal, the server can further validate the role certificate based upon other parameters of the role certificate. For example, the server can validate the role certificate in accordance the validity time of the role certificate such as by determining if the role certificate is expired. Irrespective of how the server verifies the role certificate, and thus the position of the terminal, if the server fails to verify or validate the role certificate, the server can refuse to permit the terminal to access the resources of the server.

If the server 14 verifies and validates the role certificate the terminal 16, the server can continue by verifying the characteristic(s) of the terminal based upon the permission certificate, to thereby further determine if and to what extent the terminal is authorized to access the resources of the server. Like verifying the identity and position of the terminal, the server can verify the characteristic(s) of the terminal located at its position within the organization in any of a number of different manners. In one typical embodiment, like with the role certificate, the server requires an identity certificate of the tertiary CA 32 to verify the permission certificate, and thus the characteristic(s), of the terminal. As shown in block 108, the server can therefore receive the identity certificate of the tertiary CA, such as from the terminal, the tertiary CA or another depository, in accordance with any of a number of known techniques. As will be appreciated, the server can receive the identity certificate of the tertiary CA at any time before verifying the role certificate, such before, after or as the server receives the identity certificate of the secondary CA 30.

As shown in blocks 110 and 112, after receiving the identity certificate of the tertiary CA 32, the server can verify the permission certificate by verifying the identity of the tertiary CA, and if verified, further based upon the public key of the tertiary CA, the digital signature of the terminal, and the identity of the terminal, characteristic(s) of the terminal and digital signature of the tertiary CA included within the permission certificate. Like verifying the identity certificate and role certificate of the terminal, the server can further validate the permission certificate based upon other parameters of the role certificate. For example, the server can validate the permission certificate in accordance the validity time of the permission certificate such as by determining if the permission certificate is expired. Irrespective of how the server verifies the permission certificate, and thus the characteristic(s) of the terminal, if the server fails to verify or validate the permission certificate, the server can refuse to permit the terminal to access the resources of the server. However, if the server 14 verifies and validates the characteristic(s) of the terminal 16, the server can grant the terminal access to requested resources in accordance with the identity, role and permission certificates, as shown in block 114. More particularly, the server can grant the terminal access to requested resources in accordance with the identity of the terminal, position and characteristic(s) of the terminal within the organization.

As an exemplar application of an embodiment of the present invention, again consider the example of an organization comprising a business, such as that of a cellular service provider 66 (see FIG. 5). Also consider that one or more terminals 16 comprise terminals of subscribers to services offered by the cellular network operator, where the terminals are located within one of a plurality of geographic areas 68, and are capable of varying access to the cellular network based upon a service plan (i.e., service plan A, B or C) subscription of respective customers. Further consider that one or more of the terminals can subscribe to one or more optional services within a given service plan. In such an instance, each terminal can request, and thereafter receive, an identity certificate from a primary CA 28. The terminals of each geographic area can then receive one or more role certificates from a respective secondary CA 30 authorized by the cellular network operator to issue such role certificates for the geographic area. In this regard, each role certificate can identify the position of a respective terminal as being within a particular geographic area, and subscribing to service plan A, B or C. Thereafter, the terminals within each service plan can receive one or more permission certificates from a respective tertiary CA 32 authorized by the cellular network operator to issue such permission certificates for the service plan. In this regard, each permission certificate can identify the optional service(s) of a respective terminal subscribing to a particular service plan (i.e., service plan A, B or C), and within a particular geographic area.

In one typical embodiment, then, each terminal 16 of a “preferred” customer can receive a role certificate identifying the position of the terminal as being within service plan A, each terminal of a “normal customer” can receive a role certificate identifying the position of the terminal as being within service plan B, and each terminal of a “restricted customer” can receive a role certificate identifying the position of the terminal as being within service plan C. In an alternative embodiment where each service plan builds upon a lower service plan, however, the terminals of the “preferred” and “normal” customers can receive more than one role certificates. Thus, for example, each terminal of a “preferred” customer can receive role certificates identifying the positions of the terminal as being within each of service plans A, B and C; each terminal of a “normal customer” can receive role certificates identifying the positions of the terminal as being within service plans B and C; and each terminal of a “restricted customer,” as before, can receive a role certificate identifying the position of the terminal as being within service plan C. Then, in addition to the role certificate(s), one or more terminals 16 can receive one or more permission certificates. More particularly, one or more terminals of one or more “preferred,” “normal” and/or “restricted” customers can receive a permission certificate identifying the optional services of the terminal, such as messaging services (e.g., e-mail, SMS, MMS, etc.), extended access to the cellular network(s), or the like.

After receiving the identity, role and permission certificates, the terminals 16 can then access resources of a server 14. For example, where the server controls or is otherwise associated with a BS 26 or MSC (not shown) of the cellular network 24, the terminals can access the cellular network through the BS and MSC based upon, and in accordance with, the identity and role certificates. Further, based upon, and in accordance with the permission certificates, the terminals can access the cellular network based upon, and in accordance with the permission certificates. For example, the terminals can access messaging services, such as e-mail, SMS and/or MMS services within the cellular network based upon the permission certificates. Thus, the cellular service provider can control access to the network and services within the network, through use of the identity, role and permission certificates. And in contrast to conventional techniques utilizing only identity certificates, by also using role and permission certificates that typically have a shorter validity times than identity certificates, the service provider can further control access to the network and services of the network that accounts for service subscriptions and optional services, respectively, that can be shorter in length than the validity time of a conventional identity certificate. Also, by permitting secondary and tertiary CA's 30, 32 to issue role certificates to groups of terminals within an organization and terminals within sub-groups within an organization, respectively, control over access to resources of a server can be distributed to thereby relieve a primary CA 28 of the burden of issuing, re-issuing and revoking certificates, whether identity, role or permission certificates.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
a terminal capable of communicating at least one of within and across at least one network, wherein the terminal is included within an organization including a plurality of terminals, at least one terminal having at least one characteristic and being at at least one of a plurality of positions within the organization;
a secondary certification authority (CA) capable of providing at least one role certificate to the terminal based upon the at least one position of the terminal within the organization, wherein the organization includes a plurality of secondary CA's capable of issuing at least one role certificate to respective groups of terminals of the organization;
a tertiary CA capable of providing at least one permission certificate to the terminal based upon the at least one characteristic of the terminal that is located at a position within the organization, wherein the organization includes a plurality of tertiary CA's capable of issuing at least one permission certificate to respective sub-groups of terminals of the organization; and
a server capable of authenticating the terminal based upon an identity certificate, the at least one role certificate and the at least one permission certificate of the terminal to thereby determine whether to grant the terminal access to at least one resource of the server.

2. A system according to claim 1, wherein the terminal comprises a terminal included within an organization comprising a customer base of a cellular service provider that includes a plurality of terminals, each terminal being at one of a plurality of positions comprising a plurality of service plans offered by the cellular network operator, and wherein at least one terminal has at least one characteristic comprising at least one optional service offered by the cellular network operator.

3. A system according to claim 1, wherein the terminal comprises a terminal included within an organization comprising a customer base of a cellular service provider that includes a plurality of terminals, each terminal being at at least one of a plurality of positions comprising a plurality of services offered by the cellular network operator, and wherein at least one terminal has at least one characteristic comprising at least one optional service offered by the cellular network operator.

4. A system according to claim 1, wherein the tertiary CA is capable of providing at least one permission certificate each having an associated validity time no greater than a validity time of the at least one role certificate provided by the secondary CA, and no greater than a validity time of the identity certificate.

5. A system according to claim 4, wherein the server is capable of authenticating the terminal based upon the validity times of the identity certificate, at least one role certificate and at least one permission certificate of the respective terminal.

6. A system according to claim 1, wherein the terminal is capable of requesting access to at least one resource of a server before the server authenticates the terminal, and wherein the server is capable of granting access to the at least one resource if the terminal is authenticated.

7. A method of authenticating a terminal comprising:
providing a terminal capable of communicating at least one of within and across at least one network, wherein the terminal is included within an organization including a plurality of terminals, at least one terminal having at least one characteristic and being at at least one of a plurality of positions within the organization;
providing at least one role certificate to the terminal from a secondary certification authority (CA) based upon the at least one position of the terminal within the organization, wherein the organization includes a plurality of secondary CA's capable of issuing at least one role certificate to respective groups of terminals of the organization;
providing at least one permission certificate to the terminal from a tertiary CA based upon the at least one characteristic of the terminal located at a position within the organization, wherein the organization includes a plurality of tertiary CA's capable of issuing at least one permission certificate to respective sub-groups of terminals of the organization; and
authenticating the terminal at a server based upon an identity certificate, the at least one role certificate and the at least one permission certificate of the terminal to thereby determine whether to grant the terminal access to at least one resource of the server.

8. A method according to claim 7, wherein providing a terminal comprises providing a terminal included within an organization comprising a customer base of a cellular service provider that includes a plurality of terminals, each terminal being at one of a plurality of positions comprising a plurality of service plans offered by the cellular network operator, and wherein at least one terminal has at least one characteristic comprising at least one optional service offered by the cellular network operator.

9. A method according to claim 7, wherein providing a terminal comprises providing a terminal included within an organization comprising a customer base of a cellular service provider that includes a plurality of terminals, each terminal being at at least one of a plurality of positions comprising a plurality of services offered by the cellular network operator, and wherein at least one terminal has at least one characteristic comprising at least one optional service offered by the cellular network operator.

10. A method according to claim 7, wherein providing at least one permission certificate comprises providing at least one permission certificate each having an associated validity time no greater than a validity time of the at least one role certificate, and no greater than a validity time of the identity certificate.

11. A method according to claim 10, wherein authenticating the terminal comprises authenticating the terminal based upon the validity times of the identity certificate, at least one role certificate and at least one permission certificate of the respective terminal.

12. A method according to claim 7 further comprising:
requesting, from the terminal, access to at least one resource of a server before authenticating the terminal; and
granting access to the at least one resource if the terminal is authenticated.

13. A terminal included within an organization including a plurality of terminals, each terminal having at least one characteristic and being at at least one of a plurality of positions within the organization, the terminal comprising:
a controller capable of communicating at least one of within and across at least one network, wherein the controller is capable of obtaining at least one role certificate from a secondary certification authority (CA) based upon the at least one position of the terminal within the organization and at least one permission certificate from a tertiary CA based upon the at least one characteristic of the terminal that is located at a position within the organization, wherein the organization includes a plurality of secondary CA's capable of issuing at least one role certificate to respective groups of terminals of the organization, and wherein the organization includes a plurality of tertiary CA's capable of issuing at least one permission certificate to respective sub-groups of terminals of the organization; and
a memory capable of storing an identity certificate, at least one role certificate and at least one permission certificate,
wherein the controller is also capable of communicating with a server such that the server is capable of authenticating the terminal based upon the identity certificate, the at least one role certificate and the at least one permission certificate of the terminal to thereby determine whether to grant the terminal access to at least one resource of the server.

14. A terminal according to claim 13, wherein the controller is capable of obtaining at least one role certificate from a secondary CA capable of issuing at least one role certificate to each terminal of the organization comprising a customer base of a cellular service provider that includes a plurality of terminals, each terminal being at one of a plurality of positions comprising a plurality of service plans offered by the cellular network operator, and wherein the controller is capable of obtaining at least one permission certificate based upon at least one characteristic comprising at least one optional service offered by the cellular network operator.

15. A terminal according to claim 13, wherein the controller is capable of obtaining at least one role certificate from a secondary CA capable of issuing at least one role certificate to each terminal of the organization comprising a customer base of a cellular service provider that includes a plurality of terminals, each terminal being at at least one of a plurality of positions comprising a plurality of services offered by the cellular network operator, and wherein the controller is capable of obtaining at least one permission certificate based upon at least one characteristic comprising at least one optional service offered by the cellular network operator.

16. A terminal according to claim 13, wherein the controller is capable of obtaining at least one permission certificate each having an associated validity time no greater than a validity time of the at least one role certificate obtained by the controller, and no greater than a validity time of the identity certificate.

17. A terminal according to claim 16, wherein the controller is also capable of communicating with a server such that the server is capable of authenticating the terminal based upon the validity times of the identity certificate, at least one role certificate and at least one permission certificate of the respective terminal.

18. A terminal according to claim 13, wherein the controller is capable of requesting access to at least one resource of a server before the server authenticates the terminal such that the server is capable of granting access to the at least one resource if the terminal is authenticated.
